(19) United States
(12) Patent Application Publication
(10) Pub. No.: US 2026/0205663 A1
(43) Pub. Date: Jul. 16, 2026

(54) EMBEDDING DYNAMIC CONTENT IN VIDEO DATA ALLOWING REAL-TIME INTERACTION VIA CONFIGURATION CHANGES DURING RENDERING

(71) Applicant: Microsoft Technology Licensing, LLC, Redmond, WA (US)

(72) Inventors: Brock Andrew KENZLER, Brisbane (AU); Soeren BALKO, Brookfield (AU)

(21) Appl. No.: 19/023,259

(22) Filed: Jan. 15, 2025

(51) Int. Cl. H04N 21/472; H04N 21/431; H04N 21/81; H04N 21/84

(52) U.S. Cl. CPC H04N 21/47205; H04N 21/4312; H04N 21/4318; H04N 21/816; H04N 21/84

(57) ABSTRACT

A method for embedding dynamic content into video data. The method comprises detecting, by a video editor, an indication that a piece of dynamic content is intended be rendered in a dynamic video and determining at least one dynamic variable associated with the piece of dynamic content. The method further comprises detecting a selection of a selected dynamic variable of the at least one dynamic variable and determining a dynamic interaction associated with the selected dynamic variable. The method further comprises generating the dynamic video to comprise interactive dynamic content based on the piece of dynamic content and a static video, and labeling, in metadata of a dynamic video using a backwards-compatible video format, that the dynamic interaction is configured to be performed on the interactive dynamic content to modify the selected dynamic variable during playback of the dynamic video.

### BACKGROUND

Video is a domain that is currently strictly separated between editing and playback experiences, each of which cater to different audiences and use distinct software tools and capabilities. Common video editors, such as Microsoft Clipchamp and others, enable users to assemble a timeline of media assets and effects, which they can subsequently export into a playable output video file (e.g., an MP4 file or another video file format). Common video players, such as Microsoft Windows Media Player and others, are capable of playing video files in common video file formats, but with a constrained set of operations inspired by the physical buttons of VCRs—technology dating back to the 1970s—such as play, pause, seek, adjust playback speed, and similar simple interactions.

Substantive changes to the video being displayed, and user interactions with individual objects displayed within the video (i.e., components less than the entire video frame) are not possible. In this sense, current conventional videos are static. Due to the limited available user operations, a viewer will typically merely start the video, possibly pausing, rewinding, fast forwarding, and/or changing playback speed, until the video playback completes or the viewer stops the playback.

Thus, video creators or editors must tailor the video content for viewing within the bounds of the traditional (tightly-limited) viewing operations. Further changes to the video, such as correcting errors in source material used (e.g., data displayed within the video), updating source material with newer information when it becomes available, or adjusting the viewing perspective of the source material is not possible after finalizing the video editing process, and saving and distributing the playable output video file.

### SUMMARY

The disclosed examples are described in detail below with reference to the accompanying drawing figures listed below. The following summary is provided to illustrate some examples disclosed herein.

The scope of this disclosure includes various systems and methods for embedding dynamic content into video data. One such method comprises detecting, by a video editor, an indication that a piece of dynamic content is intended to be rendered in a dynamic video and, in some examples, determining at least one dynamic variable associated with the piece of dynamic content. The method further comprises detecting a selection of a selected dynamic variable of the at least one dynamic variable and determining a dynamic interaction associated with the selected dynamic variable. The method further comprises generating the dynamic video to comprise interactive dynamic content based on the piece of dynamic content and a static video, and labeling, in metadata of a dynamic video using a backwards-compatible video format, that the dynamic interaction is configured to be performed on the interactive dynamic content to modify the selected dynamic variable during playback of the dynamic video.

### BRIEF DESCRIPTION OF THE DRAWINGS

The disclosed examples are described in detail below with reference to the accompanying drawing figures listed below:

FIG. 1 illustrates an example architecture for embedding dynamic content into video data;

FIGS. 2-4 illustrate example architectures for determining dynamic variables and corresponding dynamic interactions associated with a piece of dynamic content;

FIGS. 5-6 illustrate an exemplary user interface used for creating and rendering a dynamic video including interactive dynamic content in parallel with static video;

FIGS. 7-8 illustrate another exemplary user interface used for creating and rendering a dynamic video including interactive dynamic content in parallel with static video;

FIG. 9 illustrates another exemplary user interface used for creating a dynamic video including interactive dynamic content in parallel with static video;

FIG. 10A is a flowchart illustrating a method for embedding dynamic content into video data;

FIG. 10B is a flowchart illustrating a method for playing video data including embedded dynamic content data; and

FIG. 11 illustrates a block diagram of an example computing device suitable for implementing some of the various examples disclosed herein.

Corresponding reference characters indicate corresponding parts throughout the drawings.

### DETAILED DESCRIPTION

Conventional videos are static in nature, typically limited to basic operations such as play, pause, seek, adjust playback speed, and the like. Due to these limited interactions, a person engaging with a video will typically simply start the video and watch it from beginning to end without otherwise engaging with the video or the content presented by the video. Thus, video or content creators are limited to this video-viewing environment and must craft their video's content within the bounds of these traditional viewing operations. That is, any content that a creator wants to present in their video is typically included within the context of the static video with the understanding the future viewer viewing the video will not be able to substantially alter their viewing experience of the video other than by utilizing the basic, limited operations of play, pause, seek, and the like.

Some conventional video editing software allows for simple static modifications to a video, but these modifications are baked-in to the static audio and video streams of the video and cannot be engaged with by the person viewing the video. That is, these static modifications occur and disappear according to how the video creator defines the modifications relative to the static video timeline. As such, it is not possible for a viewer to dynamically and actively engage with pieces of content in a video. However, as will be covered in greater detail below, there are various scenarios in which a video creator may wish to add dynamic content to their video that can be interactively engaged with by the person viewing the video.

Aspects of the disclosure solve multiple problems that are necessarily rooted in computer technology and render use of computing platforms more efficient in highly common use cases, by providing the practical result of enabling already-distributed video files to be engaged with and/or modified without requiring expensive creation and distribution of substitute video files. Additionally, examples include utilizing third-party party APIs and playback software to embed dynamic content into a video file such that a future viewer of the video can interact with the dynamic content during rendering. This significantly improves the ubiquitous use of computers for viewing video files. Aspects of this disclosure allow for users (viewers) to engage with a dynamic video using rich interactions that go far beyond traditional VCR-inspired operations. These advantageous results are accomplished, at least in part, by generating a dynamic video comprising interactive dynamic content and labeling dynamic interactions associated with the dynamic content using a backwards-compatible video format in the metadata of the dynamic video to allow a viewer to modify the dynamic content using the dynamic interactions during playback. In some examples, the dynamic content is rendered in parallel with a static portion of the dynamic video such that the dynamic interactions can be performed to modify the dynamic content in parallel with the rendering of the static portion of the video.

The various examples will be described in detail with reference to the accompanying drawings. Wherever preferable, the same reference numbers will be used throughout the drawings to refer to the same or like parts. References made throughout this disclosure relating to specific examples and implementations are provided solely for illustrative purposes but, unless indicated to the contrary, are not meant to limit all examples.

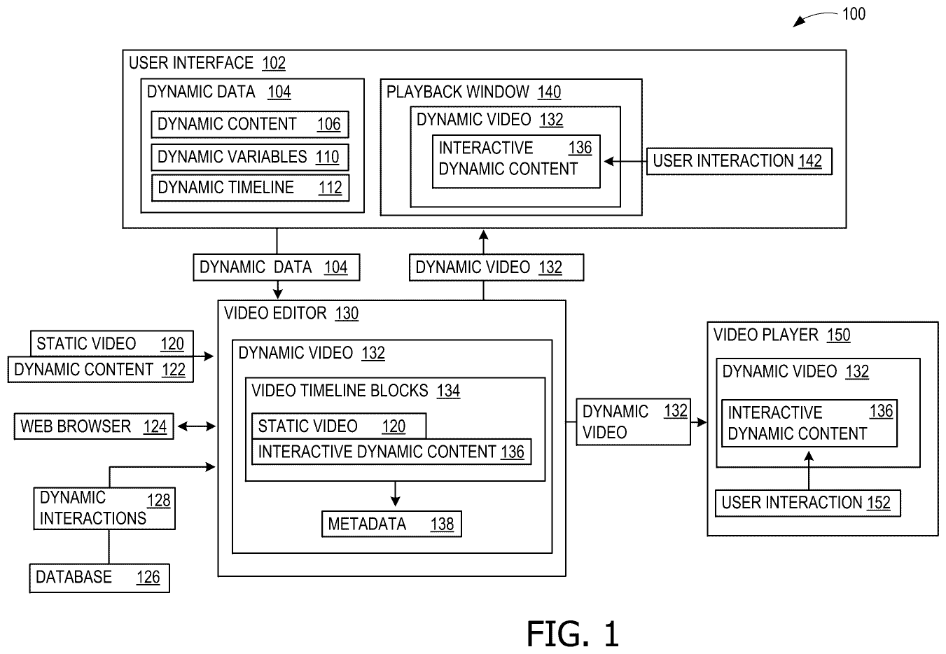

FIG. 1 illustrates an example architecture 100 for embedding dynamic content into video data. Architecture 100 includes a user interface (UI) 102 associated with a video editor 130, and can optionally further include a separate video player 150. As shown, video editor 130 ultimately creates a dynamic video 132 which includes a static video 120 rendered in parallel with interactive dynamic content 136, which can be modified by a user during playback or otherwise viewing the dynamic video 132. The dynamic video 132 can be rendered or viewed via the UI 102 and optionally the player 150.

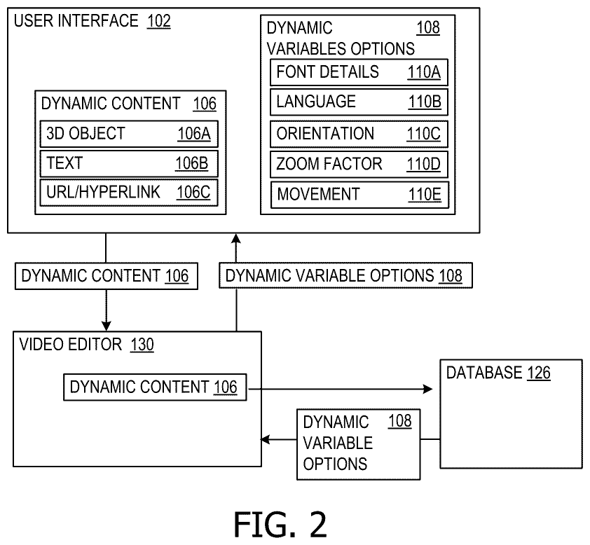

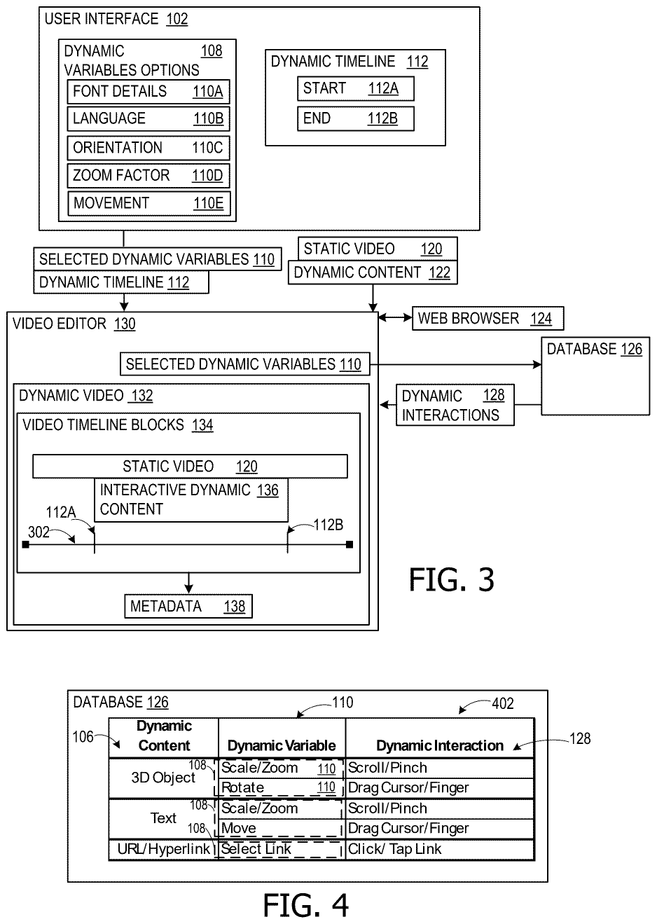

To generate the dynamic video 132, video editor 130 detects dynamic data 104 indicated by a user via the UI 102. Specifically, the dynamic data 104 can include indications of the dynamic content 106, which, as will be discussed in FIG. 2, can be a user selecting one of a plurality of different dynamic content types available for including in the dynamic video 132. Dynamic data 104 further includes indications of dynamic variables 110 associated with the dynamic content 106 (as discussed in FIG. 3), and indications related to a dynamic timeline 112 indicating where and how long the dynamic video 132 will include the dynamic features (as discussed in FIG. 3). In some examples, the dynamic features can include certain video features that are traditionally static but promoted to being dynamic, such as motion tiles, which can be represented throughout the duration of the video, and as such the associated dynamic timeline 112 corresponds with the total length of the video. For creating the dynamic video 132, the video editor 130 further receives a static video 120 and dynamic content 122. In some examples, the dynamic content 122 is included as part of the indication of dynamic content 106 of the dynamic data. In other examples, the dynamic content 122 is a different piece of data stored locally at the video editor 130 or a device hosting video editor 130. In other examples, the dynamic content 122 is stored remotely from video editor 130 and accessed by video editor 130 through a network connection. In some examples, the dynamic content 122 is accessed using web browser 124. In some examples, the dynamic content 122 is accessed using an application programming interface (API), such as an API for a third-party online video platform, for example. In some examples, the dynamic content 122 is accessed using a web widget, such as a widget for a third-party online interactive maps platform, for example. In some examples, the dynamic content 122 is stored at the device the dynamic video 132 is being played back on, such as devices associated video player 150 or user interface 102, for example. Similarly, in some examples, the static video 120 is stored locally at the video editor 130 or a device hosting video editor 130. In other examples, the static video 120 is stored remotely from video editor 130 and accessed by video editor through a network connection, such as by web browser 124 or through an API, for example.

Using the dynamic data 104, the video editor 130 references a database 126 to determine appropriate dynamic interactions 128 associated with the dynamic content 122 based on the dynamic data 104. In other examples, certain dynamic content 122 includes the associated dynamic interactions 128 as part of the metadata of the dynamic content 122. From the dynamic content 122, the video editor 130 generates interactive dynamic content 136 that can be modified by a user viewing the dynamic video 132 by using the dynamic interactions 128. Video editor 130 generates a dynamic video 132 with video timeline blocks 134 where, based on the dynamic timeline 112 data, the static video 120 and interactive dynamic content 136 are rendered together in parallel. As those with skill in the art will understand, and as shown in greater detail below, static video 120 and interactive dynamic content 136 being rendered together in parallel can include rendering the dynamic content 136 and static video 120 simultaneously and can include rendering the dynamic content 136 and static video 120 asynchronously. This data is labeled and stored accordingly in the metadata 138 of the dynamic video 132 so that it can be read and processed accordingly by a compatible viewer. The video editor 130 renders the dynamic video 132 via a playback window 140 viewable on the UI 102. A user can interact with the interactive dynamic content 136 by a user interaction 142 corresponding to dynamic interactions 128. Similarly, optionally, video editor 130 can provide dynamic video 132 to video player 150 that is compatible with video editor 130. A user can interact with the interactive dynamic content 136 by a user interaction 152 corresponding to dynamic interactions 128.

Various components of architecture 100 are implemented by a processor or multiple processors of one or multiple computing devices. Video editor 130 and associated UI 102 for example, are executable by one or more processors disclosed herein based on instructions stored to one or multiple memories disclosed herein.

FIG. 2 illustrates interactions between the UI 102, video editor 130, and database 126 in determining dynamic variable options 108 associated with a piece of identified dynamic content 106. Video editor 130 detects an indication that a piece of dynamic content 106 is meant to be embedded in video data. A user makes the indication via UI 102 by selecting an indication of a piece of dynamic content 106A-106C to include in the video data. Dynamic content 106A-106C displayed in FIG. 2 are merely illustrative examples of dynamic content, and those with skill in the art will recognize that any of a number of types of dynamic content can be included as part of this disclosure. One example of a piece of dynamic content 106 includes a three-dimensional (3D) object 106A, such as, for example, a 3D model, 3D image file, a motion tile, or any other scene graph using 3D vector-based graphics. Another example of a piece of dynamic content 106 includes interactive text 106B, such as a text box, motion tile, or other piece of text overlaying a static video for example. Another example of a piece of dynamic content 106 includes a URL or hyperlink 106C from which the piece of dynamic content can be fetched. For example, a URL can be for an online video, interactive map, editable shared document, or any other piece of online content the user decides to embed in the video data. As previously stated, dynamic content 106A-106C are merely illustrative examples of dynamic content, and those with skill in the art will recognize that any of a number of types of dynamic content can be included as part of this disclosure.

Using UI 102, a user selects one or multiple pieces of dynamic content 106A-106C for embedding in video data and video editor 130 determines which of a plurality of dynamic variable options 108 correspond with the selected piece or pieces of dynamic content 106A-106C. As shown, in some examples, video editor 130 references a database 126 storing available dynamic variable options 108 for the selected dynamic content 106A-106C. Video editor 130 retrieves the dynamic variable options from database 126 and presents the dynamic variable options via UI 102. As illustrated, some exemplary dynamic variables 110 included in dynamic variable options 108 are shown as dynamic variables 110A-110E. As will be clearer in later parts of this application, using database 126, video editor 130 determines which of dynamic variable options 108 are appropriate for and correspond to the selected piece of dynamic content 106. For example, if 3D object 106A is selected, video editor 130 may reference database 126 to determine that variables such as orientation 110C and zoom factor 110D are appropriate interactive variables for the 3D object 106A. Similarly, if text 106B is selected, video editor 130 may reference database 126 to determine that variables such as font details 110A, language 110B, zoom factor 110D, and movement 110E of the text are appropriate interactive variables for the text 106B. Thus, based on the piece of dynamic content 106 selected, video editor 130 references database 126 to determine which dynamic variables 110 are appropriate for including as the dynamic variable options 108. In other examples, certain dynamic content 106 includes the associated dynamic variables 108 as part of the metadata of the dynamic content 106, and thus video editor 130 determines the associated dynamic variables 108 associated with the selected dynamic content 106 directly from the indication of the dynamic content 106.

Using UI 102, the user then decides which of the dynamic variables 110A-110E to embed in the dynamic video 132 data as interactive dynamic variables modifiable by the viewer of the dynamic video 132. For example, going back to the example where text 106B is selected as the dynamic content, a user may select that the variables of font details 110A and movement 110E as interactive variables, but not select language 110B and zoom factor 110D as modifiable variables. That is, the user may decide to allow a person viewing the dynamic video 132 to change font details and the location of the dynamic text in the dynamic video, but not allow the person to zoom/scale or change the language of the text. In some examples, video editor 130 can default to restricting or allowing modification of certain dynamic variables 110A-110E for a given piece of dynamic content 106 by a future viewer, and the user can override the default settings using UI 102.

FIG. 3 illustrates interactions between the UI 102, video editor 130, and database 126 in determining dynamic interactions 128 associated with selected dynamic variables 110. Video editor 130 receives the selected dynamic variable 110 along with dynamic timeline 112 information defined via the UI 102. Specifically, a user may indicate a start 112A time and an end 112B time during which the selected dynamic variables 110 of the interactive dynamic content 136 can be modified by the viewer of the dynamic video 132. Video editor 130 also receives the piece of dynamic content 122 associated with the indicated dynamic content 106 selected in FIG. 2. As previously discussed, in some examples, the dynamic content 122 is included as part of the indication of dynamic content 106 as metadata of the dynamic content 106. In other examples, the dynamic content 122 is a different piece of data stored locally at the video editor 130 or a device hosting video editor 130. In other examples, the dynamic content 122 is stored remotely from video editor 130 and accessed by video editor 130 through a network connection, such as by web browser 124 or an API for example. In some examples, video editor 130 further receives the static video 120. As previously discussed, in some examples, the static video 120 is stored locally as a video file at the video editor 130 or a device hosting video editor 130. In other examples, the static video 120 is stored remotely from video editor 130 and accessed by video editor through a network connection, such as by web browser 124 or an API, for example.

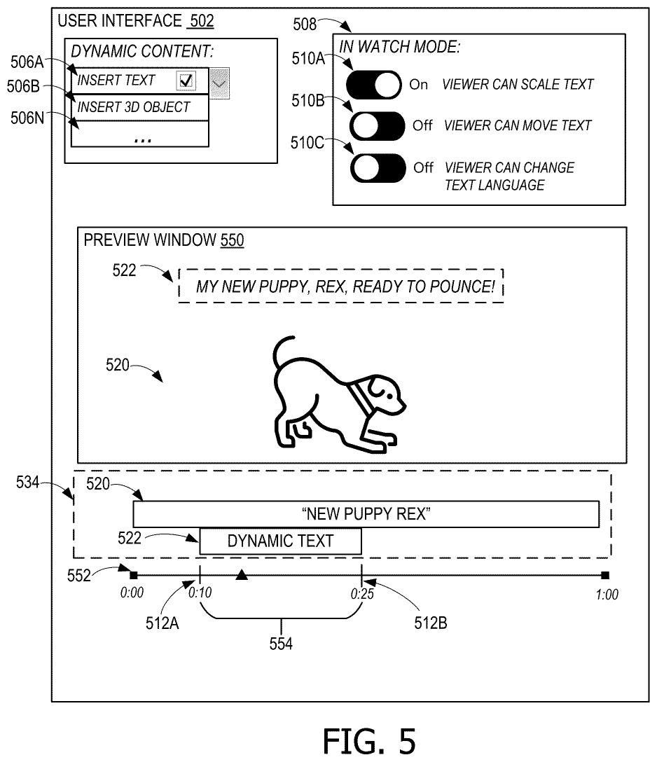

Using the selected dynamic variables 110, video editor 130 references database 126 to determine dynamic interactions 128 associated with the selected dynamic variables 110, as will be covered in greater detail in the discussion of FIG. 4. Video editor 130 then creates a piece of interactive dynamic content 136 from the dynamic content 122, which is a piece of content included in the dynamic video 132 as modifiable. Specifically, the selected dynamic variables 110 of the interactive dynamic content 136 can be modified by a user viewing the dynamic video 132 by using the dynamic interactions 128 with the interactive dynamic content 136. The dynamic video 132 includes the static video 120 and the interactive dynamic content 136 configured to be rendered together in parallel by a viewer software compatible with the video editor 130. As shown, as part of the dynamic video 132, the video editor 130 generates video timeline blocks 134 defining the start 112A and end 112B (defined by a user via UI 102) relative to a dynamic video overall timeline 302 of the dynamic video 132.

The interactive dynamic content 136 is labeled and embedded accordingly in the metadata 138 of the dynamic video 132. That is, the metadata 138 is labeled such that a compatible viewer of the dynamic video 132 is able to render the interactive dynamic content 136 and the static video 120 of the dynamic video 132 in parallel such that the selected dynamic variables 110 of the interactive dynamic content 136 can be modified by a user viewing the dynamic video 132 by using the dynamic interactions 128 with the interactive dynamic content 136. As discussed in further detail below, as part of embedding the interactive dynamic content 136 in metadata 138 and labeling the interactive dynamic content 136 as modifiable, the video editor 130 can include instructions for utilizing third-party or external software and components for rendering the modifiable interactive dynamic content 136, such as, for example, an inline frame used to embed a third-party video website through an API, a web widget used to for a third-party maps website, or a 3D engine for displaying 3D graphics in a web browser, such as Babylon.js, for example.

Video editor 130 generates dynamic video 132 in a backwards-compatible video file format, which allows playback of dynamic video 132 with existing video playback software and hardware. As part of labeling the interactive dynamic content 136 in metadata 138 as modifiable, video editor 130 embeds interactive dynamic content 136 in metadata 138 such that a future video player that makes use of the interactive dynamic content 136 and is compatible with video editor 130 can instantiate the interactive dynamic content 136 at playback time. According to various examples, video editor 130 uses existing means of common media container files, such as, for example, MP4, Quicktime, or WebM media files to store both (1) audio and video tracks that contain a statically encoded (i.e. immutable) version of the dynamic video's 132 visual and audio data and (2) extra metadata 138 that stores the structure of the video timeline blocks 134, including the interactive dynamic content 136. This metadata 138 entails the dynamic video's 132 containment hierarchy of video timeline blocks 134 (i.e. visual and audio tracks, which are comprised of visual or audio building blocks). As discussed, these building blocks can include the interactive dynamic content 136, which is a reference to an external or internal source, alongside further settings that pertain to this building block. For instance, a building block that represents external interactive dynamic content 136 with a third-part party source can be a web-based video alongside its video URL and the cut in/out timestamps. A building block that represents external content with a first-party source is an interactive maps image with its geo-coordinate, compass heading, and zoom factor. A building block that represents internal content can be motion title with rendered text provided by the video editor 130, and its positioning and styling (font, color, etc.).

Those with skill in the art will recognize that various formats of encoding the metadata 138 fall within the scope of this disclosure such as, for example, one or multiple of a JSON schema-based format, Advanced Authoring Format, and/or various other industry standard formats. Various media container formats like the ones previously discussed (MP4, Quicktime, WebM, etc.) offer similar ways to store this metadata 138 within a media file such that existing video playback software and hardware will ignore this metadata, but video players compatible with video editor 130 and dynamic video 132 can extract the metadata 138 and process it accordingly to instantiate the interactive dynamic content 136 at playback time.

FIG. 4 illustrates an example architecture of database 126 used for determining appropriate dynamic variable options 108 and dynamic interactions 128, as discussed in FIGS. 2-3. According to some examples, database 126 includes a reference table 402 referenced by video editor 130 in determining appropriate dynamic variable options 108 and associated dynamic interactions 128. As shown, table 402 includes a column listing various potential indications of dynamic content 106. Thus, based on the piece of dynamic content 106 indicated via UI 102 (in FIG. 2), using table 402, video editor 130 can determine an appropriate dynamic variable option 108 grouping for presenting at UI 102 (in FIG. 2), each variable option 108 grouping including dynamic variables 110. Based on the dynamic variable 110 of the dynamic variable options 108 selected via UI 102 (in FIG. 3), the video editor 130 can select the corresponding dynamic interaction 128 from table 402 for generating the interactive dynamic content 136. Those with skill in the art will understand a reference table 402 is used for illustrative purposes for illustrating election of appropriate dynamic variable options 108 and dynamic interactions 128, and that other means and tools for making these selections fall within the scope of this disclosure. Additionally, the lists of dynamic content 106, dynamic variables 110, and dynamic interactions 128 is a non-exhaustive list used for illustrative purposes. In some examples, the logic shown in table 402 is a hard-coded feature within video editor 130, where there is a list of known or supported dynamic content, and the associated dynamic variables 110 and dynamic interactions 128.

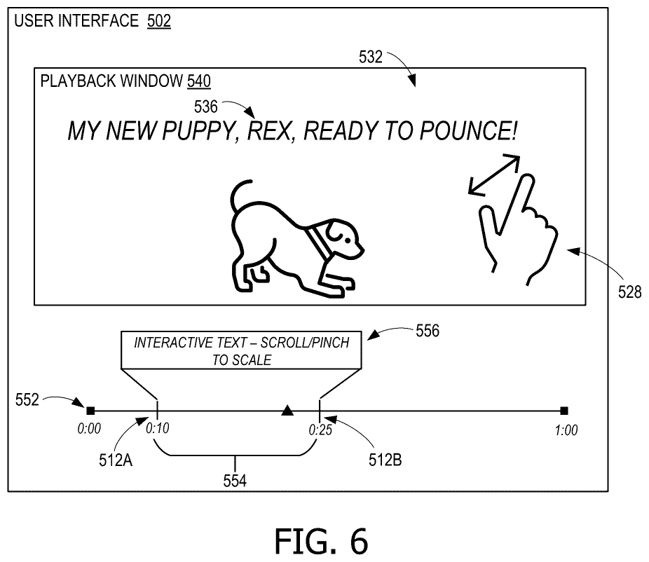

FIG. 5 illustrates an example UI 502 used for embedding dynamic content in video data. UI 502 is substantially the same as UI 102 of architecture 100, previously discussed, and FIG. 5 illustrates an exemplary use of architecture 100. As shown, through a selection window, a user is presented options for inserting different types of dynamic content 506 (substantially the same as dynamic content 106). In this example, as shown, dynamic text content 506A is selected as dynamic content. Based on this selection, video editor 130 references database 126 to select the appropriate dynamic variable option 508 (substantially the same as dynamic variable option 108) containing different selectable dynamic variables 510 (substantially the same as dynamic variables 110) corresponding to the dynamic text content 506A. As shown, in this example, the user is presented with the option of allowing the viewer of the dynamic video to scale the size of the dynamic text 510A, move the location of the dynamic text 510B, and change the language that the of the dynamic text 510C. In this example, as shown, the user has selected to allow the future viewer to scale the size of the dynamic text 510A with the associated selection switch, and selected to not allow the viewer to move the location of the dynamic text 510B or change the language of the dynamic text 510C.

During embedding of dynamic content into the dynamic video, the video editor 130 presents a preview window 550 so that the user can view progress of the dynamic video in real-time while editing. Here, the static video 520 (substantially the same as static video 120) is a video of the user's puppy, titled “NEW PUPPY REX”. Based on the selection of the dynamic text content 506A, video editor 130 allows the user to enter dynamic text 522 as the dynamic content (substantially the same as dynamic content 122) via a text box overlaying the static video 520. Here, the user uses the text box to write “MY NEW PUPPY, REX, READY TO POUNCE!”, describing the actions taken by the puppy at the corresponding point in the static video 520. The user can stretch or shrink the corresponding representation of dynamic text 522 in timeline blocks section 534 (substantially the same as timeline blocks 134) to define the start 512A and end 512B (substantially the same as start 112A and end 112B) of the dynamic text section relative to a total timeline 552 of the dynamic video (substantially the same as dynamic video timeline 302). The time between start 512A and end 512B can be referred to as a dynamic section 554 of the dynamic video. As shown in this example, the total timeline 552 corresponds to the length of static video 520. As will be understood by those in the art, in some examples the start 512A and end 512B of dynamic section 554 correspond with the start and end of the total timeline 552, and in some examples there can be multiple dynamic sections 554.

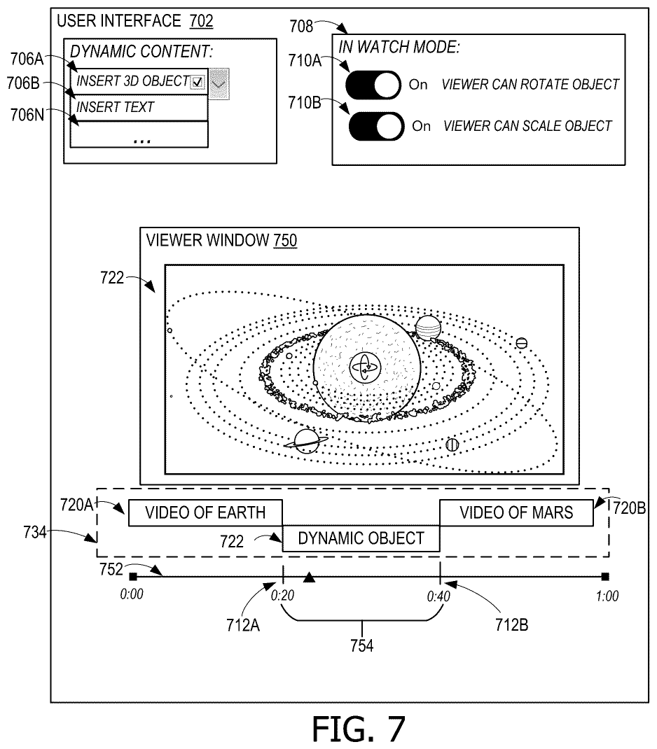

FIG. 6 illustrates UI 502 displaying a playback window 540, substantially the same as playback window 140, for viewing dynamic video 532, substantially the same as dynamic video 132. Dynamic video 532 includes interactive dynamic text 536 (substantially the same as interactive dynamic content 136), which comprises the dynamic text 522 that can be acted upon by a dynamic interaction 528 associated with the selected dynamic variable (size of the dynamic text 510A). Further, video editor 130 generates a dynamic section indicator 556, which indicates to a viewer the location of dynamic section 554 in the timeline 552 and also the type of dynamic content present in the dynamic section 554 and also how the user can interact with or modify the dynamic content. Here, the dynamic section indicator 556 states that dynamic section 554 includes interactive text that the viewer can scroll or pinch, depending on if the user is using a mouse or a touchscreen, to scale the size of the text. As illustrated, the user performs an outward pinching dynamic interaction 528 to enlarge the size text of interactive dynamic text 536.

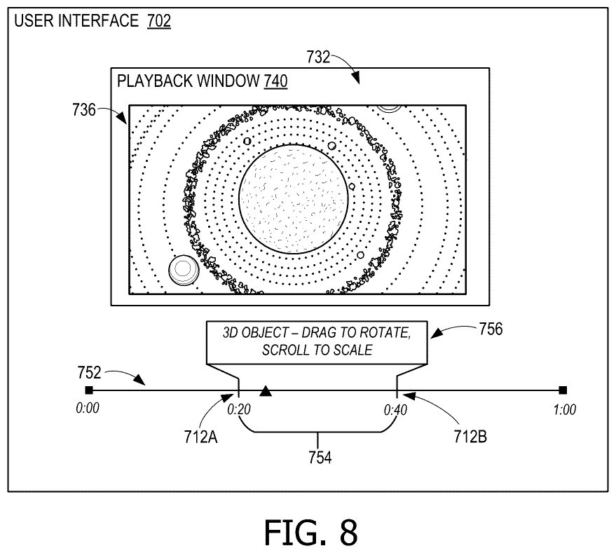

FIG. 7 illustrates an example UI 702 used for embedding dynamic content in video data. UI 702 is substantially the same as UI 102 of architecture 100, previously discussed, and FIG. 7 illustrates an exemplary use of architecture 100. As shown, through a selection window, a user is presented options for inserting different types of dynamic content 706 (substantially the same as dynamic content 106). In this example, as shown, 3D object 706A is selected as dynamic content. Based on this selection, video editor 130 references database 126 to select the appropriate dynamic variable option 708 (substantially the same as dynamic variable option 108) containing different selectable dynamic variables 710 (substantially the same as dynamic variable 110) corresponding to the dynamic 3D object 706A. As shown, in this example, the user is presented with the option of allowing the viewer of the dynamic video to rotate the dynamic 3D object 710A and scale the size of the dynamic 3D object 710B. In this example, as shown, the user has selected to allow the future viewer to rotate the 3D object 710A and also to scale the size of the 3D object 710B. The options shown are shown as an illustrative example, and those with skill in the art will understand that any affine transformation associated with a 3D scene graph are included as part of this disclosure, such as, for example. adding/removing/altering a light source, changing the field of view, removing/moving/adding objects within the 3D scene graph, altering vector orientation, etc.

During embedding of dynamic content into the dynamic video, the video editor 130 presents a preview window 750 so that the user can view progress of the dynamic video in real-time while editing. Here, the dynamic video includes multiple static videos 720A and 720B (substantially the same as static video 120), which are videos from Earth and Mars, respectively. Based on the selection of the dynamic 3D object 706A, video editor 130 allows the user to enter a 3D solar system 722 object as the dynamic content (substantially the same as dynamic content 122). Here, as shown in the timeline blocks section 734 (substantially the same as timeline blocks 134), the dynamic 3D solar system 722 object is positioned in the dynamic video between the playing of the static video of earth 720A and the static video of mars 720B. The user can stretch or shrink the corresponding representation of the dynamic 3D solar system 722 in timeline blocks section 734 to define the start 712A and end 712B (substantially the same as start 712A and end 712B) of the dynamic object section relative to a total timeline 752 of the dynamic video (substantially the same as dynamic video timeline 302). The time between start 712A and end 712B can be referred to as a dynamic section 754 of the dynamic video. As shown in this example, the total timeline 752 corresponds to the length of static videos 720A, 720B combined with the additional defined length of the dynamic section 754.

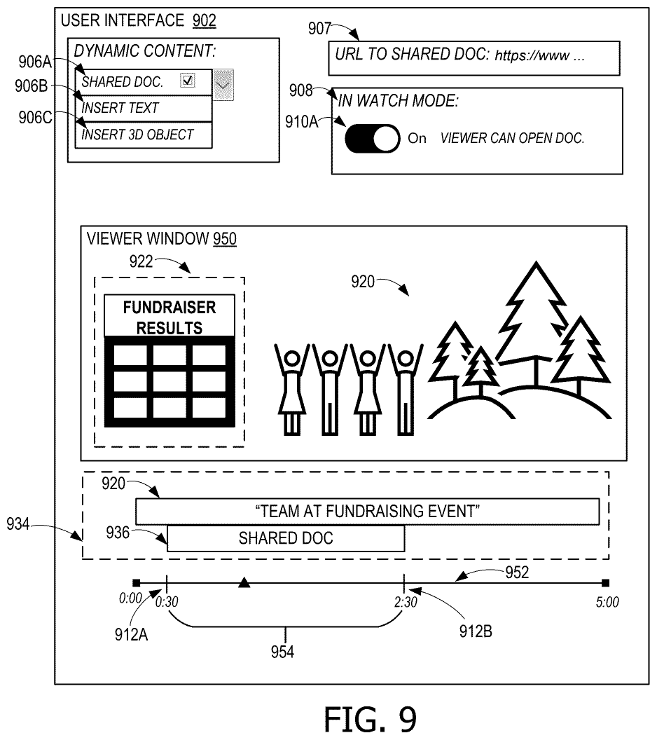

FIG. 8 illustrates UI 702 displaying playback window 740, substantially the same as playback window 140, for viewing dynamic video 732, substantially the same as dynamic video 132. Dynamic video 732 includes interactive dynamic 3D object 736 (substantially the same as interactive dynamic content 136), which comprises the dynamic 3D solar system 722 that can be acted upon by a dynamic interaction associated with the selected dynamic variables (rotate the 3D object 710A and scale the size of the 3D object 710B). Further, video editor 130 generates a dynamic section indicator 756, which indicates to a viewer the location of dynamic section 754 in the dynamic video timeline 752 and also the type of dynamic content present in the dynamic section 754 and also how the user can interact with or modify the dynamic content. Here, the dynamic section indicator 756 states that dynamic section 754 includes interactive 3D object that the viewer can drag their cursor or finger over to rotate the 3D object and scroll or pinch to scale the size of the 3D object. As illustrated, the user has used their cursor to drag and scroll over the 3D solar system to change the view from the perspective view shown in FIG. 7 to the “zoomed-in” top view shown in FIG. 8.

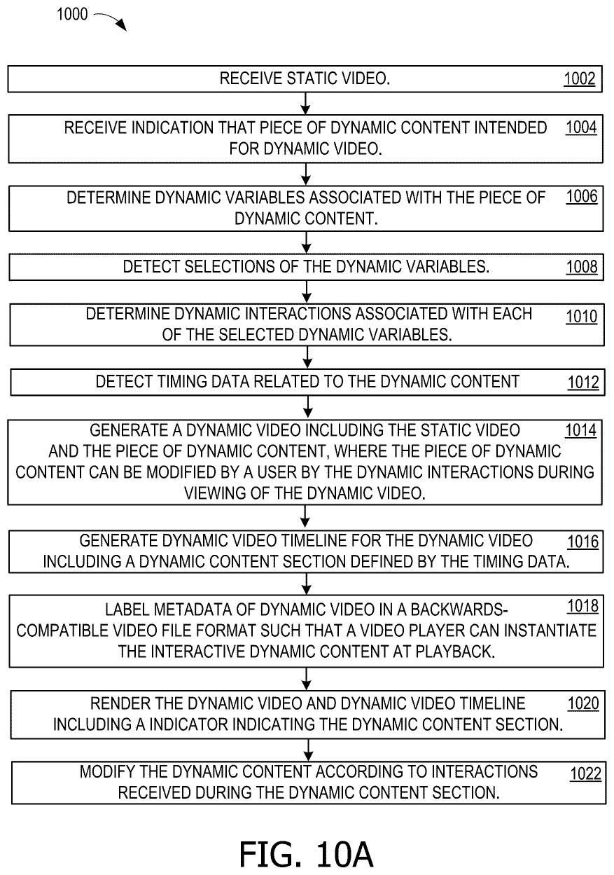

FIG. 9 illustrates an example UI 902 used for embedding dynamic content in video data. UI 902 is substantially the same as UI 102 of architecture 100, previously discussed, and FIG. 9 illustrates an exemplary use of architecture 100. As shown, through a selection window, a user is presented options for inserting different types of dynamic content 906 (substantially the same as dynamic content 106). In this example, as shown, a dynamic shared document 906A is selected as dynamic content. Based on this selection, video editor 130 references database 126 to select the appropriate dynamic variable option 908 (substantially the same as dynamic variable option 108) containing different selectable dynamic variables 910 (substantially the same as dynamic variable 110) corresponding to the dynamic shared document 906A. As shown, in this example, the user is presented with the option of allowing the viewer of the dynamic video to open the shared document 910A. In this example, as shown, the user has selected to allow the future viewer to open the shared document 910A. Additionally, upon the election of shared document 906A, video editor 130 presents URL section 907 where the user can include the URL for accessing the shared document that will be used as the dynamic content. Although a shared document is illustrated in this example, those with skill in the art will recognize that any web-based content can be used as the dynamic content, such as an online video or an interactive online map, for example, as has been previously discussed.

During embedding of dynamic content into the dynamic video, the video editor 130 presents a preview window 950 so that the user can view progress of the dynamic video in real-time while editing. Here, the static video 920 (substantially the same as static video 120) is a video of documenting highlights of team's fundraising event, and titled “TEAM AT FUNDRAISING EVENT”. Video editor 130 accesses the shared document from URL section 907 to include, as dynamic content, the desired shared dynamic shared document 922 (substantially the same as dynamic content 122) overlaying the static video 920. Here, the dynamic shared document 922 is a spreadsheet outlining the results of the team's fundraising event. The user can stretch or shrink the corresponding representation of the dynamic shared document 922 in timeline blocks section 934 (substantially the same as timeline blocks 134) to define the start 912A and end 912B (substantially the same as stats 112A and end 112B) of the dynamic text section relative to a total timeline 952 of the dynamic video (substantially the same as dynamic video timeline 302). The time between start 912A and end 912B can be referred to as a dynamic section 954 of the dynamic video. As shown in this example, the total timeline 952 corresponds to the length of static video 920. Similar to the examples already discussed in detail in FIGS. 6 and 8, video editor 130 generates a dynamic video where the dynamic shared document 922 is made interactive dynamic content where a viewer can click on the interactive dynamic content during the dynamic section 954 to access the shared document for editing the document.

The figures and associated descriptions herein offer illustrative examples of architecture 100 and other video editing architectures of this disclosure, and of how dynamic content (such as dynamic content 122, 522, 722, and 922) can be gathered and incorporated as interactive dynamic content within a dynamic video. In addition to what has already been described, dynamic content can also be captured and embedded into video data using various applications running in a web browser. Video editors of this disclosure can, by combining the use of a screen capture API along with an element capture API, inject dynamic content into a video editing or playback application and then captures the browser window and narrow the captured portion of the screen to the dynamic content. The dynamic content can be visually hidden by layering it behind the visible user interface of the video editing or playback application. In some examples, the dynamic content can be video content from on online video, the video editor can utilize a widget of the online source, which is an element that loads the video content from the online source's servers.

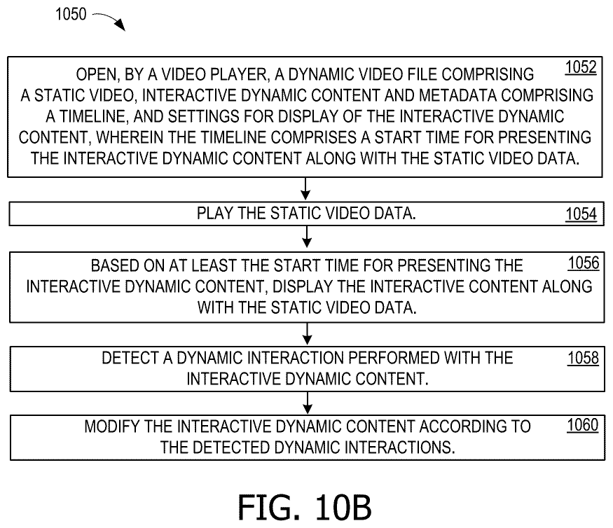

FIG. 10A is a flowchart illustrating a method 1000 for embedding dynamic content into data for a dynamic video 132. Method 1000 can start at block 1002 where video editor 130 receives a static video 120. Method 1000 can continue to block 1004 where video editor 130 receives an indication of dynamic content 106 indicating a type of dynamic content 122 to be included in the dynamic video 132 as interactive dynamic content 136. The video editor 130 further receives the indicated piece of dynamic content 122. Method 1000 can continue to block 1006 where video editor 130 determines dynamic variable options 108 associated with the dynamic content 106, such as by referencing database 126, for example. Method 1000 can continue to block 1008 where video editor 130 detects selections of dynamic variables 110 of the dynamic variable options 108. Method 1000 can continue to block 1010 where video editor 130 determines dynamic interactions 128 associated with each of the selected dynamic variables 110, such as by referencing database 126, for example. Method 1000 can continue to block 1012 where video editor 130 detects a dynamic timeline 112 related to the interactive dynamic content.

Method 1000 can continue to block 1014 where video editor 130 generates the dynamic video 132 including the static video 120 and the interactive dynamic content 136. The interactive dynamic content 136 comprises the dynamic content 122 that is interactive or modifiable during playback or rendering of the dynamic video by the dynamic interactions 128. Method 1000 can continue to block 1016 where video editor 130, using the dynamic timeline 112, generates a dynamic video timeline 302 for the dynamic video 132 and associated video timeline blocks 134 defining a dynamic section (such as dynamic sections, 554, 754, 954, for example) of the dynamic video 132. Method 1000 can continue to block 1018 where video editor 130 labels metadata 138 of dynamic video 132 in a backwards-compatible video format such that a video player can instantiate the interactive dynamic content 136 at a playback time during the dynamic section of the dynamic video 132.

Method 1000 can continue to block 1020 by rendering the dynamic video 132 and the dynamic video timeline 302 and a dynamic section indicator (such as dynamic section indicator 556, 756, for example) indicating the interactive dynamic content modifiable by the dynamic interactions 128 during the dynamic section of the dynamic video timeline 302. Method 1000 can continue to block 1022 by video editor 130, or another compatible video player, rendering the dynamic video 132, modifying the dynamic variables 110 of the interactive dynamic content 136 based on detecting the corresponding dynamic interaction 128, in the form of a user interaction 142, being performed on the interactive dynamic content 136.

Although method 1000 is described as including blocks 1002-1022, those with skill in the art will recognize that various methods including more or less than blocks 1002-1022 fall within this disclosure. Additionally, although method 1000 is described as blocks 1002-1022 occurring in a certain order, those with skill in the art will recognize that blocks 1002-1022 can be performed in any of a number of orders without departing from the scope of this disclosure.

FIG. 10B is a flowchart illustrating a method 1050 for playing a dynamic video 132. Method 1050 can be performed by video editor 130, or another video player compatible with video editor 130 and the video format of dynamic video 132, such as video player 150, as has been previously discussed. Method 1050 can begin at block 1052 where video player 150 opens the dynamic video 132, the dynamic video 132 including the static video 120, interactive dynamic content 136, and metadata 138 comprising timeline information, such as video timeline blocks 134, dynamic video timeline 302, and dynamic timeline 112 information. Method 1050 can continue to block 1054 by video player 150 playing the static video 120. Method 1050 can continue to block 1056 by video player presenting the interactive dynamic content 136 with the static video 120 data based on the occurrence of interactive timeline start 112A time in the overall dynamic video timeline 302. Method 1050 can continue to block 1058 by detecting a dynamic interaction 128, in the form of user interaction 142, 152, being performed with the interactive dynamic content 136, and then to block 1060 by modifying the interactive dynamic content 136 based on the detected dynamic interaction 128.

Although method 1050 is described as including blocks 1052-1060, those with skill in the art will recognize that various methods including more or less than blocks 1052-1060 fall within this disclosure. Additionally, although method 1000 is described as blocks 1052-1060 occurring in a certain order, those with skill in the art will recognize that blocks 1052-1060 can be performed in any of a number of orders without departing from the scope of this disclosure.

### ADDITIONAL EXAMPLES

An example system comprises: a processor operably coupled with a video editor; and a computer-readable medium storing instructions that are operative upon execution by the video editor and the processor to: detect an indication that a piece of dynamic content is intended be rendered in a dynamic video; determine, from the indication, at least one dynamic variable associated with the piece of dynamic content; detect a selection of a selected dynamic variable of the at least one dynamic variable, the selection indicating the selected dynamic variable is a variable of the dynamic content configured to be modifiable during playback of the dynamic video; determine a dynamic interaction associated with the selected dynamic variable, where the dynamic interaction is an interaction that can be performed on the dynamic content to modify the selected dynamic variable during playback of the dynamic video; generate the dynamic video to comprise interactive dynamic content based on the piece of dynamic content and a static video; and label, by the video editor in metadata of a dynamic video using a backwards-compatible video format, that the dynamic interaction is configured to be performed on the interactive dynamic content to modify the selected dynamic variable during playback of the dynamic video.

An example method for embedding dynamic content into video data comprises: detecting, by a video editor, an indication that a piece of dynamic content is intended be rendered in a dynamic video; determining, by the video editor from the indication, at least one dynamic variable associated with the piece of dynamic content; detecting, by the video editor, a selection of a selected dynamic variable of the at least one dynamic variable, the selection indicating the selected dynamic variable is a variable of the dynamic content configured to be modifiable during playback of the dynamic video; determining, by the video editor, a dynamic interaction associated with the selected dynamic variable, where the dynamic interaction is an interaction that can be performed on the dynamic content to modify the selected dynamic variable during playback of the dynamic video; generating the dynamic video to comprise interactive dynamic content based on the piece of dynamic content and a static video; and labeling, in metadata of a dynamic video using a backwards-compatible video format, that the dynamic interaction is configured to be performed on the interactive dynamic content to modify the selected dynamic variable during playback of the dynamic video.

One or more example computer storage devices have computer-executable instructions stored thereon, which, on execution by a processor, cause the processor to: detect, by a video editor, an indication that a piece of dynamic content is intended be rendered in a dynamic video; determine, by the video editor from the indication, at least one dynamic variable associated with the piece of dynamic content; detect, by the video editor, a selection of a selected dynamic variable of the at least one dynamic variable, the selection indicating the selected dynamic variable is a variable of the dynamic content configured to be modifiable during playback of the dynamic video; determine, by the video editor, a dynamic interaction associated with the selected dynamic variable, where the dynamic interaction is an interaction that can be performed on the dynamic content to modify the selected dynamic variable during playback of the dynamic video; generate, by the video editor, the dynamic video to comprise interactive dynamic content based on the piece of dynamic content and a static video; and label, by the video editor in metadata of a dynamic video using a backwards-compatible video format, that the dynamic interaction is configured to be performed on the interactive dynamic content to modify the selected dynamic variable during playback of the dynamic video.

Alternatively, or in addition to the other examples described herein, examples include any combination of the following:
rendering the dynamic video comprising the dynamic content rendered in parallel with the static in a playback window video such that the dynamic interaction can be performed to modify the selected dynamic variable of the dynamic content in parallel with the rendering of the static video;
determining a timeline for the dynamic video based at least in part on a length of the static video;
detecting a dynamic point indication indicating a dynamic section of the timeline for the dynamic interaction to be performed on the interactive dynamic content;
labeling, in the metadata of a dynamic video file, the dynamic section of the timeline as being approved for the dynamic interaction to be performed on the interactive dynamic content;
rendering, during the playback of the dynamic video, the timeline of the dynamic video and a dynamic section indicator indicating a position of the dynamic section within the timeline of the dynamic video;
wherein the dynamic section indicator includes a description of the dynamic content;
wherein the dynamic section indicator includes a description of the dynamic interaction associated with the selected dynamic variable of the dynamic content;
referencing a database in determining the at least one dynamic variable associated with the piece of dynamic content; and
referencing the database in determining the dynamic interaction associated with the selected dynamic variable.

### Example Operating Environment

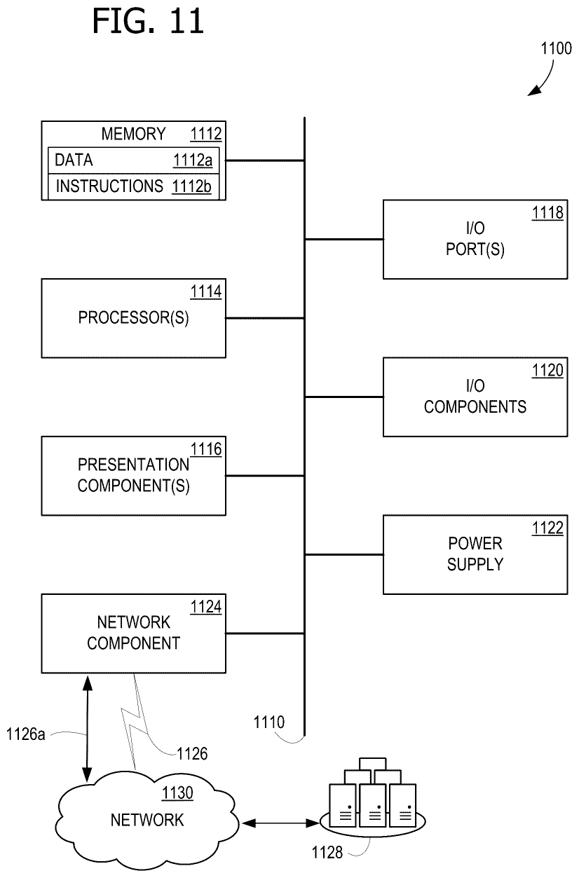

FIG. 11 is a block diagram of an example computing device 1100 (e.g., a computer storage device) for implementing aspects disclosed herein, and is designated generally as computing device 1100. In some examples, one or more computing devices 1100 are provided for an on-premises computing solution. In some examples, one or more computing devices 1100 are provided as a cloud computing solution. In some examples, a combination of on-premises and cloud computing solutions are used. Computing device 1100 is but one example of a suitable computing environment and is not intended to suggest any limitation as to the scope of use or functionality of the examples disclosed herein, whether used singly or as part of a larger set.

Neither should computing device 1100 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 1100 includes a bus 1110 that directly or indirectly couples the following devices: computer storage memory 1112, one or more processors 1114, one or more presentation components 1116, input/output (I/O) ports 1118, I/O components 1120, a power supply 1122, and a network component 1124. While computing device 1100 is depicted as a seemingly single device, multiple computing devices 1100 may work together and share the depicted device resources. For example, memory 1112 may be distributed across multiple devices, and processor(s) 1114 may be housed with different devices.

Bus 1110 represents what may be one or more buses (such as an address bus, data bus, or a combination thereof). Although the various blocks of FIG. 11 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 11 and the references herein to a “computing device.” Memory 1112 may take the form of the computer storage media referenced below and operatively provide storage of computer-readable instructions, data structures, program modules and other data for the computing device 1100. In some examples, memory 1112 stores one or more of an operating system, a universal application platform, or other program modules and program data. Memory 1112 is thus able to store and access data 1112a and instructions 1112b that are executable by processor 1114 and configured to carry out the various operations disclosed herein. Thus, computing device 1100 comprises a computer storage device having computer-executable instructions 1112b stored thereon.

In some examples, memory 1112 includes computer storage media. Memory 1112 may include any quantity of memory associated with or accessible by the computing device 1100. Memory 1112 may be internal to the computing device 1100 (as shown in FIG. 11), external to the computing device 1100 (not shown), or both (not shown). Additionally, or alternatively, the memory 1112 may be distributed across multiple computing devices 1100, for example, in a virtualized environment in which instruction processing is carried out on multiple computing devices 1100. For the purposes of this disclosure, “computer storage media,” “computer storage memory,” “memory,” and “memory devices” are synonymous terms for the memory 1112, and none of these terms include carrier waves or propagating signaling.

Processor(s) 1114 may include any quantity of processing units that read data from various entities, such as memory 1112 or I/O components 1120. Specifically, processor(s) 1114 are programmed to execute computer-executable instructions for implementing aspects of the disclosure. The instructions may be performed by the processor, by multiple processors within the computing device 1100, or by a processor external to the client computing device 1100. In some examples, the processor(s) 1114 are programmed to execute instructions such as those illustrated in the flow charts discussed below and depicted in the accompanying drawings. Moreover, in some examples, the processor(s) 1114 represents an implementation of analog techniques to perform the operations described herein. For example, the operations may be performed by an analog client computing device 1100 and/or a digital client computing device 1100. Presentation component(s) 1116 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 1100, across a wired connection, or in other ways. I/O ports 1118 allow computing device 1100 to be logically coupled to other devices including I/O components 1120, some of which may be built in. Example I/O components 1120 include, for example but without limitation, a microphone, joystick, game pad, satellite dish, scanner, printer, wireless device, etc.

Computing device 1100 may operate in a networked environment via the network component 1124 using logical connections to one or more remote computers. In some examples, the network component 1124 includes a network interface card and/or computer-executable instructions (e.g., a driver) for operating the network interface card. Communication between the computing device 1100 and other devices may occur using any protocol or mechanism over any wired or wireless connection. In some examples, network component 1124 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 1124 communicates over wireless communication link 1126 and/or a wired communication link 1126a to a remote resource 1128 (e.g., a cloud resource) across network 1130. Various different examples of communication links 1126 and 1126a include a wireless connection, a wired connection, and/or a dedicated link, and in some examples, at least a portion is routed through the internet.

Although described in connection with an example computing device 1100, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

1. A system comprising:
a processor; and
a computer-readable medium storing programming instructions for execution by the processor, the programming instructions, upon execution by the processor, causing the system to perform the following operations:
receiving a video file by a video player, the video file including audio-visual content and being configured for playback by a user;
detecting, during playback of the video file, a dynamic interaction by the user that modifies the audio-visual content within the video file;
generating, by the video player, a dynamic video file that includes the modified audio-visual content and a static audio-visual content representing an unmodified version of the audio-visual content in the video file, wherein the modified audio-visual content is embedded into metadata of the dynamic video file; and
labeling the metadata of the dynamic video file based on a backward-compatible video format, wherein labeling the metadata of the dynamic video file based on the backward-compatible video format prompts the modified audio-visual content and the static content to be rendered in parallel during rendering or playback of the dynamic video file.

2. The system of claim 1, wherein the programing instructions further cause the system to perform the following operations:
rendering or playing back the dynamic video file such that the modified audio-visual content is rendered in parallel with the static audio-visual content.

3. The system of claim 1, wherein labeling the metadata of the dynamic video file includes:
determining a timeline for the dynamic video file based at least in part on a length of the video file or the static audio-visual content;
detecting a dynamic section of the timeline during which dynamic interactions may be performed to modify the audio-visual content or the modified audio-visual content during playback of the dynamic video file; and
labeling the metadata of the dynamic video file to indicate the dynamic section of the timeline of the dynamic video file.

4. The system of claim 3, wherein the programing instructions further cause the system to perform the following operations:
rendering, during the playback of the dynamic video file, the timeline of the dynamic video file and a dynamic section indicator indicating a position of the dynamic section within the timeline of the dynamic video file.

5. The system of claim 4, wherein the dynamic section indicator identifies the modified audio-visual content as dynamic content.

6.-7. (canceled)

8. A method for embedding dynamic content into video data, comprising:
receiving a video file at a video player, the video file including audio-visual content and being configured for playback by a user;
detecting, during playback of the video file, a dynamic interaction by the user that modifies the audio-visual content within the video file;
generating, by the video player, a dynamic video file that includes the modified audio-visual content and a static audio-visual content representing an unmodified version of the audio-visual content in the video file, wherein the modified audio-visual content is embedded into metadata of the dynamic video file; and
labeling the metadata of the dynamic video file based on a backward-compatible video format, wherein labeling the metadata of the dynamic video file based on the backward-compatible video format prompts the modified audio-visual content and the static content to be rendered in parallel during rendering or playback of the dynamic video file.

9. The method of claim 8, further comprising rendering or playing back the dynamic video file such that the modified audio-visual content is rendered in parallel with the static audio-visual content.

10. The method of claim 8, wherein labeling the metadata of the dynamic video file includes:
determining a timeline for the dynamic video file based at least in part on a length of the video file or the static audio-visual content;
detecting a dynamic section of the timeline during which dynamic interactions may be performed to modify the audio-visual content or the modified audio-visual content during playback of the dynamic video file; and
labeling the metadata of the dynamic video file to indicate the dynamic section of the timeline of the dynamic video file.

11. The method of claim 10, further comprising rendering, during the playback of the dynamic video file, the timeline of the dynamic video file and a dynamic section indicator indicating a position of the dynamic section within the timeline of the dynamic video file.

12. The method of claim 11, wherein the dynamic section indicator identifies the modified audio-visual content as dynamic content.

13.-14. (canceled)

15. A computer-readable medium storing programming instructions for execution by a processor of a system, the programming instructions, upon execution by the processor, causing the system to perform the following operations:
receiving a video file at a video player, the video file including audio-visual content and being configured for playback by a user;
detecting, during playback of the video file, a dynamic interaction by the user that modifies the audio-visual content within the video file;
generating, by the video player, a dynamic video file that includes the modified audio-visual content and a static audio-visual content representing an unmodified version of the audio-visual content in the video file, wherein the modified audio-visual content is embedded into metadata of the dynamic video file; and
labeling the metadata of the dynamic video file based on a backward-compatible video format, wherein labeling the metadata of the dynamic video file based on the backward-compatible video format prompts the modified audio-visual content and the static content to be rendered in parallel during rendering or playback of the dynamic video file.

16. The computer-readable medium of claim 15, wherein the programing instructions further cause the system to perform the following operations:
rendering or playing back the dynamic video file such that the modified audio-visual content is rendered in parallel with the static audio-visual content.

17. The computer-readable medium of claim 15, wherein labeling the metadata of the dynamic video file includes:
determining a timeline for the dynamic video file based at least in part on a length of the video file or the static audio-visual content;
detecting a dynamic section of the timeline during which dynamic interactions may be performed to modify the audio-visual content or the modified audio-visual content during playback of the dynamic video file; and
labeling the metadata of the dynamic video file to indicate the dynamic section of the timeline of the dynamic video file.

18. The computer-readable medium of claim 17, wherein the programing instructions further cause the system to perform the following operations:
rendering, during the playback of the dynamic video file, the timeline of the dynamic video file and a dynamic section indicator indicating a position of the dynamic section within the timeline of the dynamic video file.

19. The computer-readable medium of claim 18, wherein the dynamic section indicator identifies the modified audio-visual content as dynamic content.

20. (canceled)

21. The computer-readable medium of claim 18, wherein the video player includes a video editor.

22. The method of claim 8, wherein the video player includes a video editor.

23. The system of claim 1, wherein the video player includes a video editor.

24. The system of claim 1, wherein the audio-visual content in the video file is dynamic content.
